(19) United States
(12) Patent Application Publication
(10) Pub. No.: US 2015/0088483 A1
(43) Pub. Date: Mar. 26, 2015

(54) SIMULATED COMPONENT CONNECTOR DEFINITION AND CONNECTION PROCESS

(71) Applicant: International Business Machines Corporation, Armonk, NY (US)

(72) Inventors: Thomas William Aarts, Leander, TX (US); Stephan Broyles, Austin, TX (US); William G. Hoffa, Austin, TX (US); Hieu C. Nguyen, Austin, TX (US)

(73) Assignee: International Business Machines Corporation, Armonk, NY (US)

(21) Appl. No.: 14/068,428

(22) Filed: Oct. 31, 2013

Related U.S. Application Data
(63) Continuation of application No. 14/036,254, filed on Sep. 25, 2013.

(51) Int. Cl. G06F 17/50

(52) U.S. Cl. CPC G06F 17/5009
USPC 703/14

(57) ABSTRACT

A dataset comprising a plurality of hardware component entries and one or more connection entries is processed. Each hardware component entry indicates a hardware component for simulation. Each connection entry indicates a plurality of hardware components to be connected. A plurality of simulated hardware components is created based, at least in part, on the plurality of hardware component entries. A simulated connection between a first simulated hardware component of the plurality of simulated hardware components and a second simulated hardware component of the plurality of simulated hardware components is created based, at least in part, on a connection entry of the one or more connection entries.

### RELATED APPLICATIONS

This application is a Continuation of and claims the priority benefit of U.S. application Ser. No. 14/036,254 filed Sep. 25, 2013.

### BACKGROUND

Embodiments of the inventive subject matter generally relate to the field of computing system simulation, and, more particularly, to managing component connections within a simulation.

Currently, hardware designers have been limited in how they could test designs without producing prototypes. Producing hardware prototypes can be expensive and time consuming, and finding a bug would mean redesigning the hardware and producing a new prototype. As computing power increased, the ability to simulate hardware prior to producing a hardware prototype also improved. More recently, computing power and hardware simulators have evolved enough that entire computing systems can be simulated.

Computing systems consist of many different components, including processors, memory chips, hard drives, network controllers, etc. Further, each of these different components can be complex, including multiple levels of additional components. Modeling complete systems can involve accurately modeling each individual component of the system. Modeling the components and the interconnections between the components, while also ensuring the correctness of the model can be tedious and time consuming. Thus, techniques that simplify or accelerate the design of the components and systems can save many man-hours.

### SUMMARY

Embodiments include a method comprising processing a dataset. The dataset comprises a plurality of hardware component entries and one or more connection entries. Each hardware component entry of the plurality of hardware component entries indicates a hardware component for simulation and each connection entry of the one or more connection entries indicates a plurality of hardware components to be connected. The method also includes creating a plurality of simulated hardware components based, at least in part, on the plurality of hardware component entries. The method also includes creating a simulated connection between a first simulated hardware component of the plurality of simulated hardware components and a second simulated hardware component of the plurality of simulated hardware components based, at least in part, on a connection entry of the one or more connection entries.

### BRIEF DESCRIPTION OF THE DRAWINGS

The present embodiments may be better understood, and numerous objects, features, and advantages made apparent to those skilled in the art by referencing the accompanying drawings.

FIG. 1 is a conceptual diagram depicting operations for utilizing a component connection dataset to initialize a simulation in a hardware simulator, according to some embodiments.

FIG. 2 depicts a flowchart of example operations for using a component connection dataset to initialize a hardware simulation, according to some embodiments.

FIG. 3 depicts an example computer system for processing a component connection dataset and initializing a hardware simulation.

### DESCRIPTION OF EMBODIMENT(S)

The description that follows includes example systems, methods, techniques, instruction sequences and computer program products that embody techniques of the present inventive subject matter. However, it is understood that the described embodiments may be practiced without these specific details. For instance, although examples refer to simulation of computing system hardware, the inventive subject matter also applies to the simulation of hardware other than computing system hardware. In other instances, well-known instruction instances, protocols, structures and techniques have not been shown in detail in order not to obfuscate the description.

Hardware simulators are not limited to modeling single computing systems either. For example, hardware simulators can model networks including multiple computing systems and other devices. However, to avoid obfuscating the descriptions herein, the described embodiments will focus on the modeling of a single computing system. The inventive subject matter can apply to more complex implementations, such as those involving multiple computing systems and other devices.

Each component in a computing system can be coupled with many other components. The resulting network of connections allows the various components to communicate, thus resulting in a functioning computing system. Functionality that appears very basic from a user's point of view may actually involve a large number of communications between various components. For example, writing a single value to a hard drive may involve writing the value to a register on a processor core, writing the value to multiple levels of cache (and possibly replicating the cache change to other cores), writing the value to memory over a memory bus, writing the value over a Peripheral Component Interconnect (PCI) bus, then writing it to the hard disk. Each component can consist of other components that communicate as well. For example, the PCI bus may also include a PCI controller that broadcasts the address the value is being written to and the value itself to each component connected to the PCI bus. Thus, accomplishing very basic functionality can involve communicating over hundreds of individual connections.

A component can be viewed as a “black box” that includes one or more “interfaces”. An interface is analogous to a component connector, such as an individual wire connection or a multi-wire connector. While some components only support one interface, other components support multiple interfaces. Consider a computing system backplane. A backplane might include one or more slots for PCI expansion cards (hereinafter “PCI slots”), one or more ports for Serial Advance Technology Attachment (SATA) devices (hereinafter “SATA ports”), etc. Thus each component interface is associated with, at the very least, a unique name identifying the particular interface. An example backplane that comprises three PCI slots would include three interfaces. The three interfaces of the example backplane could be named “PCI_{—1}”, “PCI_{—2}”, and “PCI_{—3}”, for example.

However, most computing systems include components that are not directly compatible with each other, such as PCI expansion cards and SATA devices. Thus, as a practical matter each interface is typically associated with a particular “type”, in addition to a name. For example, the above example backplane might further comprise three SATA ports, with each SATA port being represented by an interface. The three interfaces representing the SATA ports could be named “SATA_{—}1”, “SATA_{—}2”, and “SATA_{—}3”. It would make little sense to connect a SATA device to a PCI slot, because the protocols used by a SATA device are not directly compatible with the protocols used by a PCI bus. In a non-simulated environment, such scenarios are prevented by utilizing unique physical connectors that are not compatible with other technologies. In other words, in a physical system a SATA device uses a connector that is designed to connect to a SATA port, which has a unique shape that is incompatible with a PCI slot.

In a simulated environment, there are no such physical mechanisms available to restrict which components are connected. Associating each interface with a particular “type” and only permitting interfaces with compatible types to connect simulates the physical mechanisms that prevent incompatible components from being connected. The interface types can vary between implementations, and the interface types do not have to be directly analogous to physical connectors. For example, the interface type may be representative of the actual data that would be transmitted over the connection, such as binary bits transmitted in serial or in parallel. The interface types can be higher level data types as well, such as representing integers or Boolean values. Further, the interface types can be representative of the various communication protocols used by the particular components, such as representing Ethernet packets.

To connect two components in a hardware simulator together, a programmer writes program code indicating that data put on a first interface of the first component is communicated to a first interface of the second component. Thus, the programmer identifies the two components and identifies the two interfaces that are to communicate. However, this technique can be tedious and error-prone. If the program code is included with the components themselves, the components can only be reused without modification if the connections do not change. If the program code is not included with the components, it can be difficult to find the appropriate code. Further, modifying program code directly can result in recompiling the entire simulator, which can be time consuming.

However, a hardware simulator can process a component connection dataset that includes component connection definitions. The component connection definitions can comprise component entries and connection entries. Each component entry in the component connection dataset can include an indication of the component, a unique identifier for the component, and a set of one or more interface entries. Each interface entry can include an interface type and at least one name that is unique among the interfaces of the particular component. Each connection entry can include the unique identifiers for the components to be connected, as well as the names of the interfaces for the components that are to be connected. The hardware simulator can validate the interface types referred to by a connection entry by comparing the types identified in the respective component entries. The hardware simulator can then initialize the hardware simulation by creating the individual components and the connections.

The component connection dataset is separate from program code (i.e., is read and processed by program code, but is not executed like program code). By making the component connection definitions separate from the program code, program code does not get modified with every change to the hardware configuration that is being simulated. Thus, the probability of introducing bugs in the actual hardware simulator is reduced.

Further, a component connection dataset that is independent from program code allows for better integration with configuration utilities. For example, a graphical user interface (GUI) could be implemented that allows for a user to select components from a component library and indicate which components are connected. The GUI can then save, or export, the configuration into the format specified for the dataset. If an independent component connection dataset is not used, the GUI would generate program code. If the program code was modified to use a different programming language, refactored, or otherwise changed, the GUI might then be modified as well. By using an independent component connection dataset, the program code can be updated independently of any utility that operates on the dataset.

Further, the component connection dataset can facilitate validation of a hardware specification. As described above, a component connection dataset that is independent from program code facilitates creating the hardware configuration. Thus, a component connection dataset can be generated from a hardware specification created during the hardware design phases. For example, the hardware specification may be processed by a utility that determines the components included in the hardware specification and how they are connected. The utility can then output the component connection dataset in a format compatible with the hardware simulator. This can reduce the number of steps using human labor, thus potentially reducing the number of errors introduced. Further, the dataset can be processed to determine that the connected components specified in the hardware specification are compatible, as described below. Thus, instead of manually creating the hardware simulation configuration from the hardware specification and running simulated test cases to determine whether the hardware specification is valid, the dataset is created directly from the hardware specification and validated without having to run a simulation and various test cases. This can significantly reduce the amount of work involved in detecting design bugs in the hardware specification, while also reducing the potential for human error.

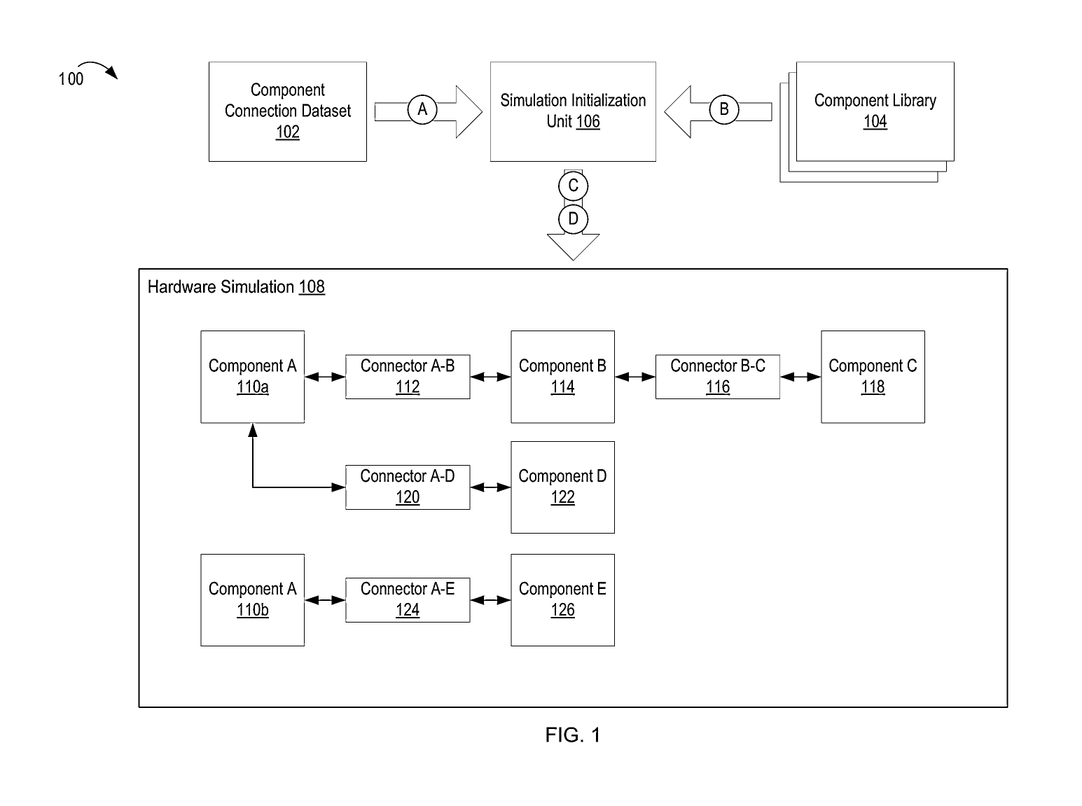

FIG. 1 is a conceptual diagram depicting operations for utilizing a component connection dataset to initialize a simulation in a hardware simulator, according to some embodiments. FIG. 1 depicts a hardware simulator environment 100, including a component connection dataset (hereinafter “dataset”) 102, a component library 104, and a simulation initialization unit 106. FIG. 1 also depicts a visual representation of a hardware simulation configuration (hereinafter “hardware simulation”) 108, including a set of components and connectors (described in detail below).

The dataset 102 can be represented in a variety of ways. For example, the dataset 102 can be stored as a file or set of files, in a database, embedded in source code, etc. If stored as a file or set of files, the dataset 102 can be a text file, binary file, etc. The format of the dataset 102 can vary according to how the dataset 102 is stored. For example, if stored as a file or set of files, the dataset 102 can be represented as eXtensible Markup Language (XML) formatted text, JavaScript® Object Notation (JSON) formatted text, a custom format, etc. If stored in a database, the dataset 102 can be stored in a manner similar to that of a file or set of files or stored in accordance with a database schema. If embedded in source code, the dataset 102 can be formatted in a manner compatible with the particular programming language and/or data structure used. Further, the dataset 102 can be represented by using a combination of different techniques. For example, the dataset 102 may be stored in a database in accordance with a database schema and converted into XML formatted text before being used by a hardware simulator. Specific examples of possible formats are described in further detail below.

At stage A, the simulation initialization unit 106 loads the dataset 102. The manner in which the dataset 102 is loaded can vary according to the manner in which the dataset 102 is stored. For example, if the dataset 102 is stored as a text file, the text file may be read into memory from a specified location on a disk. If the dataset 102 is stored in a database, the simulation initialization unit 106 may query the database. The simulation initialization unit 106 may perform further processing to the dataset 102. For example, if the dataset 102 is stored as XML formatted text, the simulation initialization unit 106 may parse the XML formatted text. Once loaded, the dataset 102 can be represented using a variety of data structures, such as an array, an object, or a tree.

The dataset 102 comprises a set of component entries and a set of connection entries as described above. The set of component entries comprises at least a subset of the components of the hardware that is being simulated. Some components of the hardware that is being simulated may not be connected to other components or may be specified in other manners, and thus may not be included in the dataset 102.

At stage B, the simulation initialization unit 106 loads the components specified in the component entries of the dataset 102 from the component library 104. The component library 104 is a collection of components that are available for the hardware simulation 108. For example, the components in the component library 104 may represent processors, memory, video cards, etc. Further, the components in the component library 104 may be composed of other components in the component library 104. For example, a processor component in the component library 104 may be composed of one or more processor core components in the component library 104. The processor core component may further be composed of one or more register components in the component library 104.

Similar to the dataset 102, the component library 104 can be specified in a variety of ways. For example, each component may be represented by an individual source code file that is loaded by the hardware simulator or represented by a row in a relational database. In some implementations, the simulation initialization unit 106 loads all components in the component library 104. In some implementations, the simulation initialization unit 106 loads the components specified by the dataset 102, which may be a subset of the components in the component library 104. Thus, the manner in which the simulation initialization unit 106 loads the components from the component library 104 can vary.

As described above, each component entry comprises an indication of the component as well as a unique identifier. For example, the indication of the component might be the name of a class that defines the component. The actual program code associated with the component class definition might be stored in a particular location based on the class name. The simulation initialization unit 106 can then load the component class definition from the location by using the class name.

At stage C, the simulation initialization unit 106 creates the loaded components. The manner in which the simulation initialization unit 106 creates the loaded components can vary between implementations. For example, in some implementations, the simulation initialization unit 106 creates a data structure for each component using values loaded at stage B. In some implementations, the simulation initialization unit 106 instantiates an object based on a class definition loaded at stage B.

Each created component is associated with the unique identifier indicated in the respective component entry from the dataset 102. For example, each created component can be stored in a map structure by providing the map structure with a unique identifier and reference to the associated component. The simulation initialization unit 106 can then retrieve the component associated with a unique identifier by passing the unique identifier to the map structure, receiving a reference to the component in return.

At stage D, the simulation initialization unit 106 creates the connections specified in the dataset 102. As described above, each connection entry includes the unique identifiers of the two components to be connected and the names of the respective interfaces to be connected. The simulation initialization unit 106 uses the unique identifiers to retrieve the references to the two components from the map structure as described above. The simulation initialization unit 106 can then retrieve information related to the particular interfaces specified. For example, the simulation initialization unit 106 may refer to the component entries in the dataset 102 that are associated with the unique identifiers or query the components themselves. The simulation initialization unit 106 compares the types associated with the two interfaces to verify that the interfaces are compatible. If the interfaces are not compatible, the simulation initialization unit 106 can generate an error. If the interfaces are compatible, the simulation initialization unit 106 can create the connections.

The connections between the various components can be simulated in a variety of ways, depending on the underlying implementation. For example, the simulation initialization unit 106 may operate such that the simulation initialization unit 106 generates program code that gets compiled and becomes part of the simulator prior to the simulation being run. The simulation initialization unit 106 may operate such that the simulation initialization unit 106 interacts with a running simulation. For example, the simulation initialization unit 106 may indicate to one or more instantiated component objects that the component objects are to communicate with a particular connector.

In some implementations, the connections can be represented as actual components called connectors. For example, some interfaces can be repeating interfaces. A repeating interface is capable of connecting to two different components. When the repeating interface receives data from one component, the interface transmits the data to the other component and vice versa, thus acting as a bridge between the two components. When represented as a component, the connection entry can include one or more interface entries. The interface entries can each include an interface type. The interface type can be utilized to validate the interface type of the components, thus ensuring the compatibility of the component interfaces. The interface entries can include the unique identifiers of the components as well as the name of the interface for each component, thus indicating which component interfaces are to be connected by the connector.

The simulation initialization unit 106 can support various combinations of components and connectors in the dataset 102. The hardware simulation 108 depicts several example combinations of components and connectors. For example, a first instance of component A 110a is connected with component B 114 by connector A-B 112. Similarly, component B 114 and component C 118 are connected by connector B-C 116. The connection of component A 110a to component B 114 and the connection of component B 114 to component C 118 may allow component A 110a to communicate with component C 118.

Components can have multiple interfaces, as described above. In the hardware simulation 108, the first instance of component A 110a is also connected to component D 122 by connector A-D 120. Thus, component A 110a can communicate with component D 122 in addition to component B 114.

Further, multiple instances of a component can be created. For example, a second instance of component A 110b is connected to a component E 126 by connector A-E 124. Utilizing multiple instances of component can simulate multiple units of hardware with similar traits, such as two similar memory chips in a computing system.

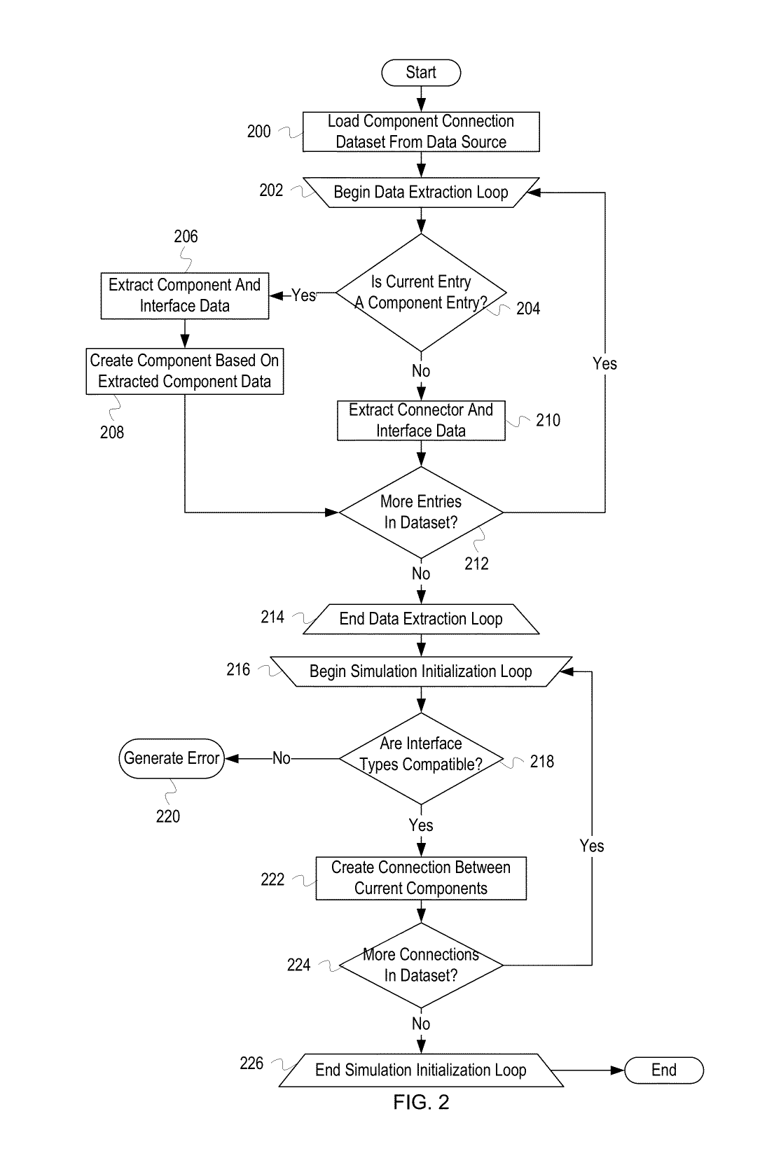

FIG. 2 depicts a flowchart of example operations for using a component connection dataset to initialize a hardware simulation, according to some embodiments.

Beginning at block 200, a simulation initialization unit of a hardware simulator loads a dataset from a data source. The specific operations used to load the dataset can vary depending on the data source. For example, if the data source is a file system, the simulation initialization unit reads a file or set of files containing the dataset from the file system. If the data source is a database, the simulation initialization unit queries the database for the relevant dataset, which might be a subset of a larger dataset. Implementations using other data sources can similarly result in the utilization of various operations for loading the dataset from the particular data source type. After the simulation initialization unit loads the dataset from the data source, control then flows to block 202.

At block 202, the simulation initialization unit begins a data extraction loop. The dataset comprises component entries and connector entries. During the data extraction loop, the simulation initialization unit extracts the individual component entries and connector entries. During the initial pass through block 202, the simulation initialization unit initializes any data used during the data extraction loop. For example, the simulation initialization unit may initialize a set of statistics for the loop or initialize a file pointer referencing a file containing the dataset. On each additional pass through block 202, the initialization unit updates any data used during the data extraction loop. In particular, the simulation initialization unit initializes and maintains an indication of a current entry. The current entry is a subset of the data representing either a component entry or a connector entry. Processing of the dataset to determine the current entry may include sub-operations. For example, if the dataset is stored in a file, each entry may comprise multiple lines in the file, and thus the simulation initialization unit might read multiple lines of the file in order to establish the current entry. After initializing or updating the data used during the data extraction loop, control then flows to block 204.

At block 204, the simulation initialization unit determines if the current entry is a component entry. The operations performed by the simulation initialization unit to determine if the current entry is a component entry can vary depending on how the dataset is stored, formatted, and loaded. For example, the dataset may be stored in a file according to a known format, and the simulation initialization unit can check to see if a particular value associated with the current entry matches a value used to indicate that the current entry is a component entry. Similarly, if the dataset is stored in a database according to a particular database schema, the simulation initialization unit can check to see if a particular value associated with a column in the database schema matches a value used to indicate that the current entry is a component entry. If the simulation initialization unit determines that the current entry is a component entry, control then flows to block 206. If the simulation initialization unit determines that the current entry is not a component entry, control then flows to block 210.

At block 206, the simulation initialization unit extracts component and interface data from the current entry, which was determined to be a component entry at block 204. Component entries can be comprised of a unique identifier for the component and one or more interface entries. The one or more interface entries can be comprised of an interface type and at least one interface name. Any interface name associated with an interface entry is unique to that interface among all interfaces associated with the particular component entry. The interface name serves as a unique identifier for the particular interface it is associated with.

The extraction of the component and interface data involves operations that can vary depending on the implementation of the dataset and the previously performed operations. For example, in some implementations, extracting the component and interface data may comprise parsing text data that is stored in a known format. In some implementations, the simulation initialization unit might use utilities or libraries that parse the dataset as it is read, such as an XML parser. The simulation initialization unit might then access a data structure that represents the current entry as returned by the utility or library. Similarly, in some implementations, the simulation initialization unit might access a data structure representing a result set containing the current entry, as returned in response to a database query. After the simulation initialization unit extracts the component and interface data from the current entry, control then flows to block 208.

At block 208, the simulation initialization unit creates a component based on the extracted component data. For example, the extracted component data may indicate the parameters of the component, which the simulation initialization unit uses to populate a data structure representing the component. The extracted component data may also indicate a particular class of an object-oriented programming language that defines the component, which can be loaded and instantiated by the simulation initialization unit. The interface data may also be utilized to create the component. When the component is created, it is generally added to some form of map structure in which the component is associated with the unique identifier included in the component data. By mapping the component with the unique identifier, the simulation initialization unit can use the unique identifier to reference the specific component. After the simulation initialization unit creates the component based on the extracted component data, control then flows to block 212.

Control flowed to block 210 if the simulation initialization unit determined that the current entry is not a component entry at block 204. At block 210 the simulation initialization unit extracts connection and interface data from the current entry. Because the dataset comprises component entries and connector entries, the current entry is a connector entry if it is not a component entry. The extraction of the connection and interface data can be performed in a manner substantially similar to the extraction of component and interface data described at block 206. Similarly, the connector entry and interface entries associated with the connector entry can be comprised of data similar to that of the component entries. Similarly, the connection data can be stored in a data structure for later use by the simulation initialization unit. Some implementations may include entries other than component entries and connector entries, in which case the simulation initialization unit may perform further determination operations to determine that the current entry is a connection entry. After the simulation initialization unit extracts the connector and interface data, control then flows to 212.

Control flowed to block 212 from block 208 and block 210. At block 212, the simulation initialization unit determines if more entries exist in the dataset. For example, the simulation initialization unit might determine whether a file pointer referencing a file in which the dataset is stored has reached the end of the file; the simulation initialization unit might determine that no more results exist in a result set from a database query, etc. If the simulation initialization unit determines that more entries exist in the dataset, control then flows back to block 202. If the simulation initialization unit determines that no more entries exist in the dataset, control then flows to block 214.

At block 214, the data extraction loop ends. By the end of the data extraction loop, all entries of the dataset have been iterated over, all components indicated in the dataset have been created and all connector data has been extracted. The simulation initialization unit can perform any cleanup operations related to the data extraction loop, such as closing file pointers or database connections. After the data extraction loop ends, control then flows to block 216.

At block 216, the simulation initialization unit begins a simulation initialization loop. During the simulation initialization loop, the simulation initialization unit validates the compatibility of the interfaces that should be connected, as indicated by the connector data. If the interfaces validate, the simulation initialization unit creates the connections between the components that are indicated by the connector data. During the first pass through block 216, any data used during the simulation initialization loop is initialized. During subsequent passes through block 216, data used during the simulation initialization loop is updated as appropriate. In particular, the simulation initialization loop iterates over each set of connection data. Each individual connection data is associated with a connection entry from the data set, and the connection data being iterated over is the current connection. Further, each connection specifies at least two components that are to be connected and the interfaces of the components that should be connected. The components specified by the connection are the current components. After the simulation initialization unit initializes or updates the simulation initialization loop data, control then flows to block 218.

At block 218, the simulation initialization unit determines if the interface types associated with the specified connection are compatible. Because components are connected via their interfaces, the connection specifies the unique identifier for each component and the unique names associated with the particular interfaces to connect. Further, the interface type can be queried from the component or can be specified in metadata related to the component. Thus, the simulation initialization unit determines the interface types of the component interfaces that are to be connected, and determines whether the interface types are compatible. If the interface types are not compatible, the connection cannot be made. The determination of compatibility can vary between implementations. For example, compatibility may be determined by comparing the values representing the interface types and determining if they match. If an object-oriented programming language is used, compatibility may be determined by classes representing each interface type are compatible classes (e.g., are derived from the same parent class). If the simulation initialization unit determines that the interface types associated with the specified connection are not compatible, control then flows to block 220. If the simulation initialization unit determines that the interface types associated with the specified connection are compatible, control then flows to block 222.

At block 220, the simulation initialization unit generates an error indicating that the component interfaces specified by the connector cannot be connected. Such an error generally indicates an error in the dataset, which may be caused by human error or an error in a specification describing the system hardware. After generating the error indicating that the component interfaces specified by the connector cannot be connected, the process ends.

Control flowed to block 222 if the simulation initialization unit determined that the interface types specified by the connector data are compatible at block 218. At block 222, the simulation initialization unit creates the connection between the current components. Creating the connection can be done by generating program code that links the specified component interfaces together, creating a connector component that includes a repeating interface, etc. After the simulation initialization unit creates the connection between the current components, control then flows to block 224.

At block 224, the simulation initialization unit determines if there are more connections in the dataset. If the connection data is stored in a data structure, the simulation initialization unit can determine that there are no more connections by determining that the simulation initialization unit has iterated over all connection data in the data structure. If the simulation initialization unit determines that there are more connections in the dataset, control then flows back to block 216. If the simulation initialization unit determines that there are no more connections in the dataset, control then flows to block 226.

At block 226, the simulation initialization loop ends. At the end of the simulation initialization loop, the simulation initialization unit has iterated over each connection specified in the dataset. The simulation initialization unit has further validated the interface types for each component to be connected and generated each connection between the specified component interfaces. The simulation initialization unit can perform operations to clean up any data used for the simulation initialization loop. After the simulation initialization loop ends, the process ends.

As an example flowchart, FIG. 2 presents operations in an example order from which embodiments can deviate (e.g., operations can be performed in a different order than illustrated and/or in parallel). For example, the simulation initialization unit can further determine if all components referenced by a connection have been extracted and created at block 210. If all components referenced have been created, the simulation initialization unit can perform the operations of the simulation initialization loop (blocks 218-222) after block 210.

As will be appreciated by one skilled in the art, aspects of the present inventive subject matter may be embodied as a system, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. A computer readable storage medium does not include signals.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

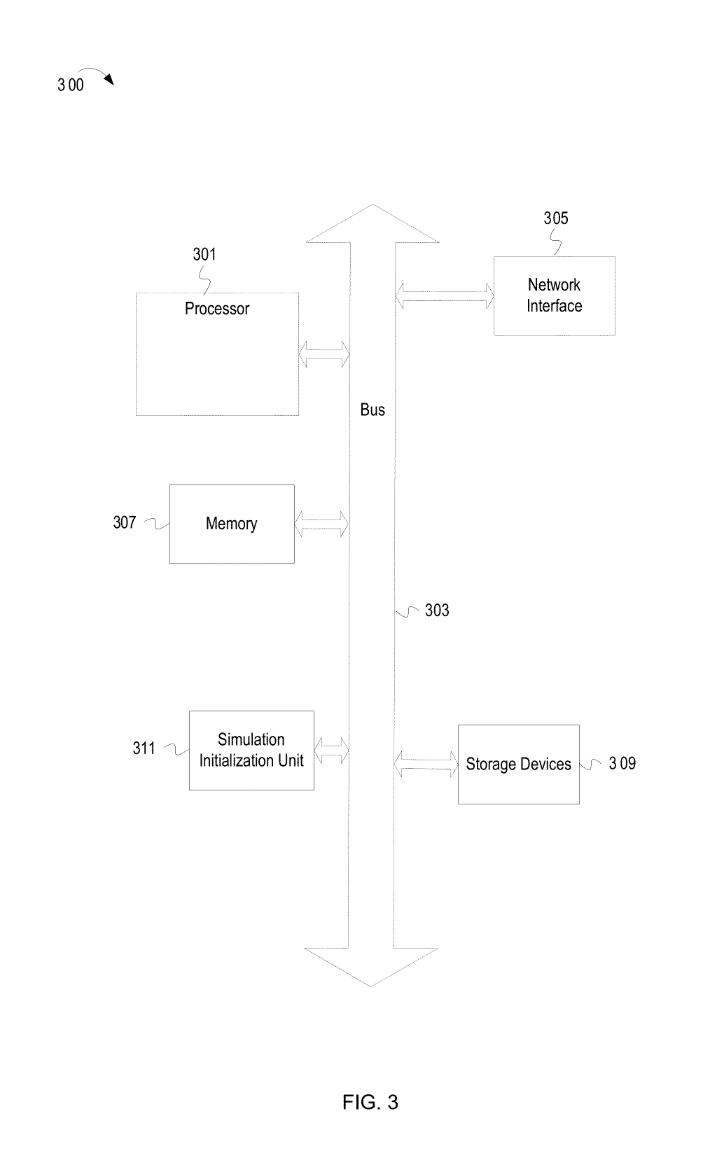

FIG. 3 depicts an example computer system for processing a component connection dataset and initializing a hardware simulation. A computer system 300 includes a processor 301 (possibly including multiple processors, multiple cores, multiple nodes, and/or implementing multi-threading, etc.). The computer system 300 includes memory 307. The memory 307 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system 300 also includes a bus 303 (e.g., PCI, ISA, PCI-Express, HyperTransport®, InfiniBand®, NuBus, etc.), a network interface 305 (e.g., an ATM interface, an Ethernet interface, a Frame Relay interface, SONET interface, wireless interface, etc.), and a storage device(s) 309 (e.g., optical storage, magnetic storage, etc.). The computer system 300 also includes a simulation initialization unit 311. The simulation initialization unit 311 embodies functionality to implement embodiments described above. The simulation initialization unit 311 may include one or more functionalities that facilitate the processing of a component connection dataset to determine the components to be simulated in a hardware simulator and the connections between the components. The simulation initialization unit 311 may also include one or more functionalities that facilitate the creation of the components to be simulated as well as creating the connections between the components. Any one of these functionalities may be partially (or entirely) implemented in hardware and/or on the processor 301. For example, the functionality may be implemented with an application specific integrated circuit, in logic implemented in the processor 301, in a co-processor on a peripheral device or card, etc. Further, realizations may include fewer or additional components not illustrated in FIG. 3 (e.g., video cards, audio cards, additional network interfaces, peripheral devices, etc.). The processor 301, the storage device(s) 309, and the network interface 305 are coupled to the bus 303. Although illustrated as being coupled to the bus 303, the memory 307 may be coupled to the processor 301.

While the embodiments are described with reference to various implementations and exploitations, it will be understood that these embodiments are illustrative and that the scope of the inventive subject matter is not limited to them. In general, techniques for managing component connections within a simulation as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the example configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
processing a dataset comprising a plurality of hardware component entries and one or more connection entries, wherein each hardware component entry of the plurality of hardware component entries indicates a hardware component for simulation, wherein each connection entry of the one or more connection entries indicates a plurality of hardware components to be connected;
creating a plurality of simulated hardware components based, at least in part, on the plurality of hardware component entries; and
creating a simulated connection between a first simulated hardware component of the plurality of simulated hardware components and a second simulated hardware component of the plurality of simulated hardware components based, at least in part, on a connection entry of the one or more connection entries.

2. The method of claim 1, wherein each hardware component entry of the plurality of hardware component entries comprises an indication of the hardware component for simulation, a unique identifier, and one or more interface entries, wherein each interface entry of the one or more interface entries comprises an interface type and one or more unique identifiers.

3. The method of claim 1, wherein each connection entry of the one or more connection entries comprises a unique identifier and one or more interface entries, wherein each interface entry of the one or more interface entries comprises an interface type, a plurality of hardware component identifiers, and a plurality of interface identifiers, wherein the indication of the plurality of hardware components to be connected comprises the plurality of hardware component identifiers and the plurality of interface identifiers.

4. The method of claim 1 further comprising:
retrieving a reference to the first simulated hardware component of the plurality of simulated hardware components;
retrieving a reference to the second simulated hardware component of the plurality of simulated hardware components; and
determining that an interface type associated with the first simulated hardware component of the plurality of simulated hardware components matches an interface type associated with the second simulated hardware component of the plurality of simulated hardware components;
wherein said creating the simulated connection between the first simulated hardware component of the plurality of simulated hardware components and the second simulated hardware component of the plurality of simulated hardware components is responsive to said determining that the interface type associated with the first simulated hardware component of the plurality of simulated hardware components matches the interface type associated with the second simulated hardware component of the plurality of simulated hardware components.

5. The method of claim 1 further comprising:
determining that an interface type associated with the first simulated hardware component of the plurality of simulated hardware components does not match an interface type associated with the second simulated hardware component of the plurality of simulated hardware components; and
responsive to said determining that the interface type associated with the first simulated hardware component of the plurality of simulated hardware components does not match the interface type associated with the second simulated hardware component of the plurality of simulated hardware components, generating an error indicating that the interface type associated with the first simulated hardware component of the plurality of simulated hardware components does not match the interface type associated with the second simulated hardware component of the plurality of simulated hardware components.

6. The method of claim 1, wherein said processing the dataset comprising the plurality of hardware component entries and one or more connection entries comprises:
reading a file from a file system, wherein the file contains data representing the dataset, wherein the data in the file is stored in accordance with a defined format; and
parsing the data contained in the file.

7. The method of claim 1, wherein said processing the dataset comprising the plurality of hardware component entries and one or more connection entries comprises querying a database for data representing the dataset.

8. The method of claim 1 further comprising generating the dataset based, at least in part, on a hardware specification.
